(19) United States
(12) Patent Application Publication
(10) Pub. No.: US 2016/0232512 A1
(43) Pub. Date: Aug. 11, 2016

(54) Information Generating Method, Information Processing Device, and POS System

(71) Applicant: SEIKO EPSON CORPORATION, Tokyo (JP)

(72) Inventors: Yoshihiro Ueno, Matsumoto-Shi (JP); Akio Takamoto, Shiojiri-Shi (JP)

(73) Assignee: Seiko Epson Corporation, Tokyo (JP)

(21) Appl. No.: 15/024,179

(22) PCT Filed: Dec. 10, 2014
(86) PCT No.: PCT/JP2014/006165

§ 371 Date: Mar. 23, 2016

(30) Foreign Application Priority Data
Dec. 13, 2013 (JP) 2013-258024
Nov. 17, 2014 (JP) 2014-232432

(51) Int. Cl. G06Q 20/20

(52) U.S. Cl. CPC G06Q 20/209

(57) ABSTRACT

An information generating method that uses data input/output by an existing device enables communicating information with higher utility value without changing existing applications. An information generating method of a computer with an application includes an input data acquisition step of acquiring input data before the input data is input to the application; an output data acquisition step of acquiring output data of the application before the output data is output from the computer; and a synthesizing step of combining the acquired input data and the acquired output data and generating information.

### TECHNICAL FIELD

The present invention relates to information generating technology that uses input and output data of an existing device, and relates particularly to an information generating method and an information processing device that can generate information of high utility value without changing an existing application.

### BACKGROUND

POS systems, or point-of-sale systems, are common today in supermarkets and other retail businesses, and in such systems plural terminal devices (registers) connected to a server over a network operate and run various processes according to applications installed on the terminal devices. A barcode reader, printer, and other peripheral devices are normally connected to each terminal device, and these devices are used to input data and output receipts and coupons related to the products sold.

After such POS systems are deployed, the need to add new functions or change existing functions arises as technology improves and business needs change. However, because such systems are central to business operations, in constant use, and complexly intertwined with other systems, modifying the applications that run on a system is not trivial. New functions that may be desirable in such systems include collecting sales information and sales analysis.

PTL 1 cited below addresses this problem. The device described in PTL 1 acquires print data for a receipt that is output from the POS application, and executes a process of extracting and outputting sales information from that data to a sales analysis program.

### CITATION LIST

### Patent Literature

[PTL 1] JP-A-2012-185635

### SUMMARY OF INVENTION

### Technical Problem

However, because the sales information output for sales analysis is generated from the information printed on a receipt in the device described in JP-A-2012-185635, the information is of limited use to the product manufacturer because the content of the generated sales information is limited and the product names that are used may be for that particular store or store chain. In other words, the sales information is information that lacks in usefulness and generality.

An objective of the invention is therefore to provide an information generating method that uses the input/output data of an existing device and can produce information with higher utility value without modifying existing applications.

### Solution to Problem

To achieve the foregoing objective, one aspect of the invention is an information generating method of a computer with an application, including: an input data acquisition step of acquiring input data before the input data is input to the application; an output data acquisition step of acquiring output data of the application before the output data is output from the computer; and a synthesizing step of combining the acquired input data and the acquired output data and generating information.

Further preferably in another aspect of the invention, the input data is information about a product that was sold; and the output data is print data for a receipt related to the sold product.

Further preferably in another aspect of the invention, the information generated in the synthesizing step includes a standardized product code of the sold product.

Further preferably in another aspect of the invention, the information generated in the synthesizing step includes sale date and store information acquired from the output data for each standardized product code.

Further preferably, the information generating method according to the invention also has a related information acquisition step of acquiring related information of the sold product from a database to which the computer connects based on the input data.

Further preferably in another aspect of the invention, the related information includes a formal name and price information for the sold product; and the information generated in the synthesizing step includes the formal name and price information for each standardized product code.

Further preferably in another aspect of the invention, the related information includes local name information for the sold product; and information generated in the synthesizing step includes the local name information for each standardized product code.

Further preferably in another aspect of the invention, the related information includes local code information for the sold product; and the information generated in the synthesizing step includes the local code information for each standardized product code.

Further preferably, the information generating method according to the invention also has an output step of outputting information generated in the synthesizing step to an external device.

Further preferably in another aspect of the invention, the input data is input from a barcode reader; and the output data is output to a printer.

Further preferably in another aspect of the invention, the input data acquisition step and the output data acquisition step execute on the kernel layer of the operating system of the computer; and the synthesizing step executes on the application layer of the computer.

To achieve the foregoing objective, another aspect of the invention is an information processing device with an application, including: an input data acquisition unit that acquires input data before the input data is input to the application; an output data acquisition step that acquires output data of the application before the output data is output from the information processing device; and an information synthesis unit that combines the acquired input data and the acquired output data and generates information.

### Advantageous Effects of Invention

An information generating method according to the invention that uses input/output data of an existing device can generate information with high utility value without changing an existing application.

Further objectives and features of the invention will become clear from the embodiments of the invention described below.

### BRIEF DESCRIPTION OF DRAWINGS

FIG. 1 is a network configuration diagram related to an embodiment of a POS terminal device according to the invention.

FIG. 2 is a block diagram of the functional configuration of the POS terminal device.

FIG. 3 is a flow chart of steps in the sales information generating process that is executed during the payment process.

FIG. 4 shows an example of sales information generated by an information synthesis utility 210 according to a first embodiment of the invention.

FIG. 5 shows an example of sales information generated by an information synthesis utility 210 according to a second embodiment of the invention.

### DESCRIPTION OF EMBODIMENTS

An embodiment of the invention is described below with reference to the accompanying figures. Note, however, that the embodiments described below do not limit the technical scope of the invention. In addition, identical or similar parts are identified by the same reference numerals or symbols below in the accompanying figures.

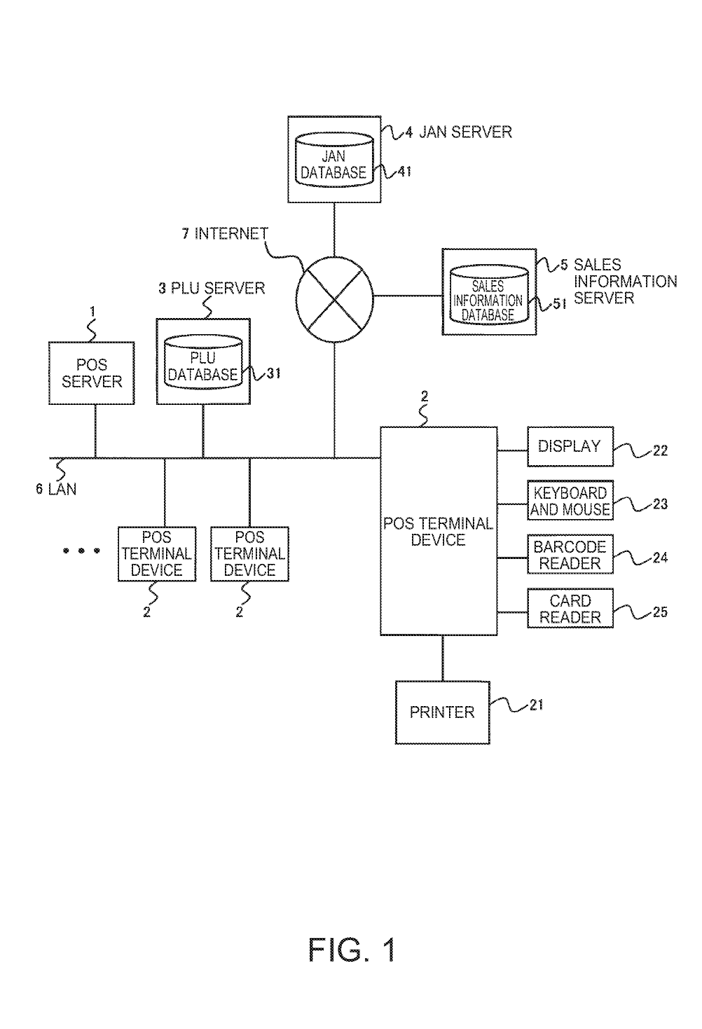

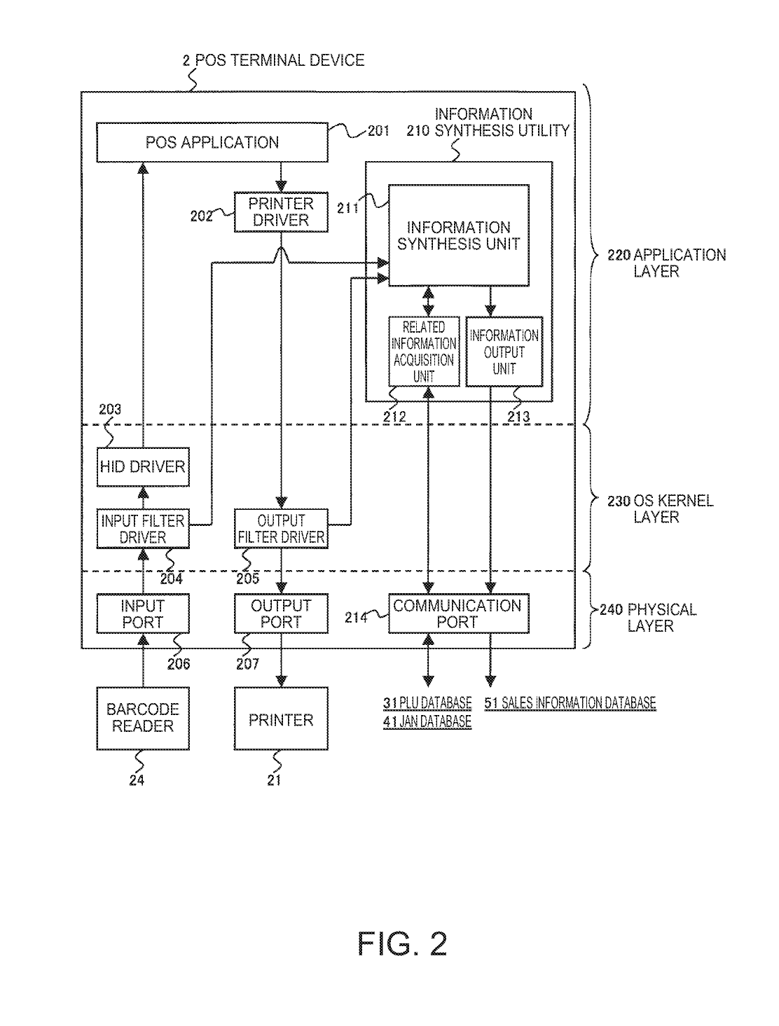

FIG. 1 illustrates the network configuration related to a POS terminal device according to the invention. FIG. 2 illustrates the functional configuration of the POS terminal device. The POS terminal device 2 (information processing device) shown in FIG. 1 and FIG. 2 is a device that applies the invention. During the payment process at the point of sale, for example, this device acquires the product code (such as the JAN (Japan Article Number) code) input from a barcode reader 24 (external device) before the product code is acquired by the POS application 201, and acquires the output data for a receipt that is output by the POS application 201 based on the input data before the receipt output data is acquired by the output port 207. Next, the POS terminal device 2 combines the acquired data, adds related information, and generates the sales information. This process of the POS terminal device 2 does not require modifying the POS application 201, and can generate information with high utility value related to product sales. Note that in the following examples, data input from a barcode reader or other external device is called input data, and data output to a printer or other external device is called output data.

This embodiment of the invention anticipates a POS system such as used in a retail store, and as shown in FIG. 1 has a plurality of POS terminal devices 2 connected through a LAN (local area network) to a POS server 1. The POS server 1 is a computer system, and executes processes including managing the multiple POS terminal devices 2 and collecting and managing data acquired from the POS terminal devices 2.

A PLU server 3 is connected to the LAN 6, and the PLU (price look-up table) server 3 stores a PLU database 31. The PLU database 31 is a database (storage device) that stores the price of each product sold in the store, and stores information such as the product name (referred to below as the local name) used in the store, the product code (referred to below as the local code) that is used in the store, and the price relationally to the standard product code of each product.

A standard product code is a generic, widely used product code (a standardized product code). The embodiment is described below using the JAN code as an example of a standard product code. This code is contained in the barcode information assigned to each product, and products can be uniquely identified in Japan using this code.

The PLU server 3 is a computer system, and the PLU database 31 may be stored on the POS server 1. The PLU database 31 is maintained by the POS system administrator, and the latest information (local name, local code, price, for example) of a product in the store can be retrieved using the JAN code.

As shown in FIG. 1, the POS system of the store can communicate with external sites through the Internet 7. A JAN server 4 and sales information server 5 are located at an external site.

The JAN server 4 stores a JAN database 41. The JAN database 41 is a database (storage device) that stores product information relationally to a JAN code. The stored information is information that can be widely shared, such as the official name of a product, and is maintained by a group that manages the JAN database 41. The JAN server 4 is a computer system.

The sales information server 5 stores a sales information database 51. The sales information database 51 is a database (storage device) that stores sales information generated by the POS terminal device 2. The information stored in this database is information generated by the invention, and information about the products sold in the store is accumulated in the database. The sales information server 5 is also a computer system.

A POS terminal device 2 is installed at each checkout counter in the store, and is connected to peripheral devices (external devices). Examples of the peripheral devices in this embodiment of the invention include a printer 21, display 22, keyboard and mouse 23, barcode reader 24, and a card reader 25.

The printer 21 is a printing device that outputs receipts, for example, according to the print data output from the POS terminal device 2. The POS terminal device 2 is the host device of the printer 21, and to print a receipt, for example, outputs print data to the printer 21 and instructs the printer 21 to print.

The display 22 is a display device for displaying product price information, for example, for the customer. The keyboard and mouse 23 are input devices used by the operator to input data, and are used to input the quantity when more than one of the same product is purchased, and to input the local code when the information cannot be acquired with the barcode.

The barcode reader 24 is a device for reading barcodes from products, and may be a barcode scanner, for example. The JAN code of a product is input by the barcode reader 24 to the POS terminal device 2. The card reader 25 reads information stored on card media, and acquires customer information and information required to process payment.

The POS terminal device 2 generates and outputs to the printer 21 information to be printed on a receipt, for example, based on information input from the keyboard and mouse 23, barcode reader 24, and card reader 25. The POS terminal device 2 is a computer, and has a CPU, RAM, ROM, and hard disk drive not shown in the figures. Programs such as the POS application 201 described below, printer driver 202, and information synthesis utility 210 are stored in ROM or on the hard disk drive, and processes are executed by the CPU operating according to these programs.

The POS terminal device 2 has a functional configuration such as shown in FIG. 2. The POS application 201 controls a process of generating and outputting information printed on receipts as described above, for example. A barcode reader 24 is used as the input device in the example shown in FIG. 2.

The printer driver 202 is a printer driver for the printer 21, and outputs data output from the POS application 201 as print data containing commands that are dependent on the model of printer 21 (device). Note that the POS application 201 and printer driver 202 are embodied by programs that are stored in ROM or the disk drive and define the steps performed by specific parts, and a CPU and other hardware executing the processes according to the programs.

As shown in FIG. 2, the POS application 201 and printer driver 202 reside on the application layer 220 where programs that run under the operating system (OS) of the computer execute processes. The POS application 201 and printer driver 202 are the POS application and printer driver that were used on the existing system to which the invention is applied, and are used without modification.

An information synthesis utility 210 also resides on the application layer 220. The information synthesis utility 210 is the part that generates the information stored in the sales information database 51 by combining the data input to the POS terminal device 2 from the barcode reader 24 and card reader 25, and print data output from the printer driver 202.

As shown in FIG. 2, the information synthesis utility 210 includes an information synthesis unit 211, a related information acquisition unit 212, and an information output unit 213. The information synthesis unit 211 is the part that runs the information synthesizing process; the related information acquisition unit 212 is the part that acquires related information from the PLU database 31 and JAN database 41; and the information output unit 213 is the part that converts the synthesized sales information to data in the format stored in the sales information database 51 and outputs the converted data. The specific content of the processes executed by these parts is described further below.

The information synthesis utility 210 is embodied by a program stored in ROM or the disk drive specifying the steps to be executed by each part, and a CPU and other hardware that runs the program and executes processes accordingly.

The OS kernel layer 230 where the operating system resides includes an HID driver 203, input filter driver 204 (input data acquisition unit), and output filter driver 205 (output data acquisition unit).

The HID driver 203 (Human Interface Device) is a driver for the barcode reader 24 in this example, and is the part that receives input data from the barcode reader 24 and passes the received data to the POS application 201 in a format that can be understood by the POS application 201. In this example, the input data from the barcode reader 24 is received through the input filter driver 204.

The input filter driver 204 acquires input data from the barcode reader 24 before the HID driver 203, and passes the acquired information to the information synthesis unit 211. When the program of the input filter driver 204 is installed on the POS terminal device 2, the registry is configured when the operating system boots so that input data from the barcode reader 24 is first passed to the input filter driver 204, and the foregoing acquisition of information is achieved by this registry setting.

The output filter driver 205 is the part that acquires print data output from the POS application 201 through the printer driver 202 on the OS kernel layer 230 before the output port 207 acquires the print data. The acquired print data is passed from the output filter driver 205 to the information synthesis unit 211. When the program of the output filter driver 205 is installed on the POS terminal device 2, the registry is configured when the operating system boots so that input data sent to the output port 207 is first received by the output filter driver 205, and the foregoing acquisition of information is achieved by this registry setting.

The HID driver 203, input filter driver 204, and output filter driver 205 are embodied by programs stored in ROM or the disk drive specifying the steps to be executed by each part, and a CPU and other hardware that runs the program and executes processes accordingly.

Note that the information synthesis utility 210, input filter driver 204, and output filter driver 205 programs described above embody an information generating program.

The POS terminal device 2 has an input port 206, output port 207, and communication port 214 on the physical layer 240. The barcode reader 24 connects to the input port 206, and the printer 21 connects to the output port 207. The POS terminal device 2 communicates through the communication port 214 over the LAN 6 and Internet 7.

The POS terminal device 2 according to this embodiment of the invention configured as described above is characterized by the sales information generating process that is executed during the payment process for a product sale, and the specific content of this process is described below.

### Embodiment 1

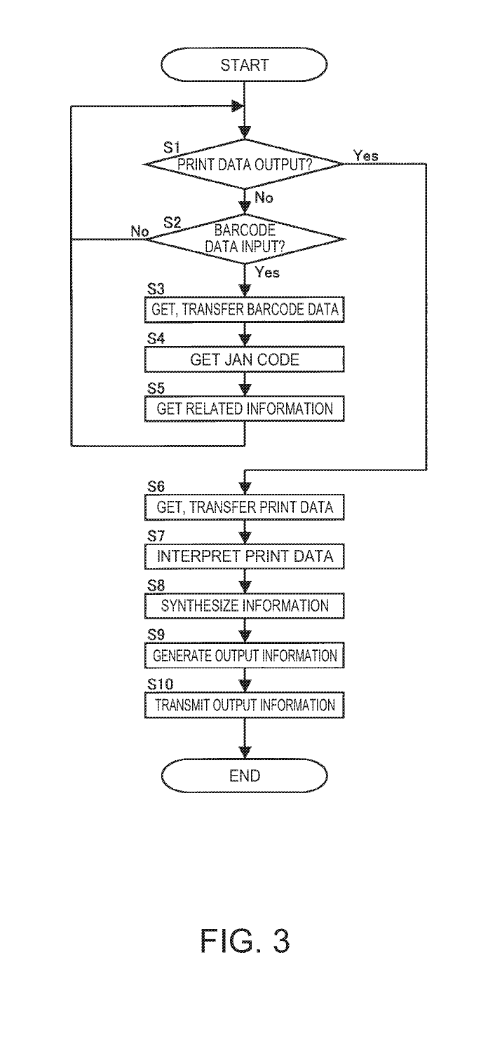

FIG. 3 is a flow chart showing steps in the sales information generating process executed during a payment process. The process executed when processing one customer purchase transaction, that is, a process corresponding to outputting one receipt, is described next with reference to FIG. 3.

The operator of the POS terminal device 2 first reads the barcode affixed to each product the customer purchases with the barcode reader 24. When one product is scanned with the barcode reader 24, the read data (input data) is input from the input port 206 to the POS terminal device 2. Note that, because print data for a receipt is still not output at this point, the process follows NO from step S1 in the flow shown in FIG. 3, and because barcode data was input, the process follows YES from step S2.

The input barcode data is, as described above, first received by the input filter driver 204 (step S1 in FIG. 3 returns NO, and step S2 returns YES). The input filter driver 204 acquires and passes the barcode data to the information synthesis unit 211 of the information synthesis utility 210 (step S3 in FIG. 3, input data acquisition step). The barcode data is then input through the HID driver 203 to the POS application 201.

The information synthesis unit 211 interprets the transferred barcode data and acquires the JAN code of the product in the barcode data (step S4 in FIG. 3). Next, the acquired JAN code is passed to the related information acquisition unit 212, and the related information acquisition unit 212 executes a process of acquiring related information for that product (step S5 in FIG. 3, related information acquisition step).

Related information as used here is information about the purchased products, and means added information not contained in the data input from the barcode reader 24 or other peripheral device, and not contained in the print data that is output to the printer 21.

In the related information acquisition process, the related information acquisition unit 212 first accesses the JAN database 41 through the Internet 7, and using the JAN code as the search key, acquires the formal name of the product relationally stored to the JAN code.

The related information acquisition unit 212 also accesses the PLU database 31 through the LAN 6, and using the JAN code as the search key, acquires the local name and price of the product relationally stored to the JAN code.

The acquired related information, which in this example is the formal name, local name, and price, is then passed to the information synthesis unit 211.

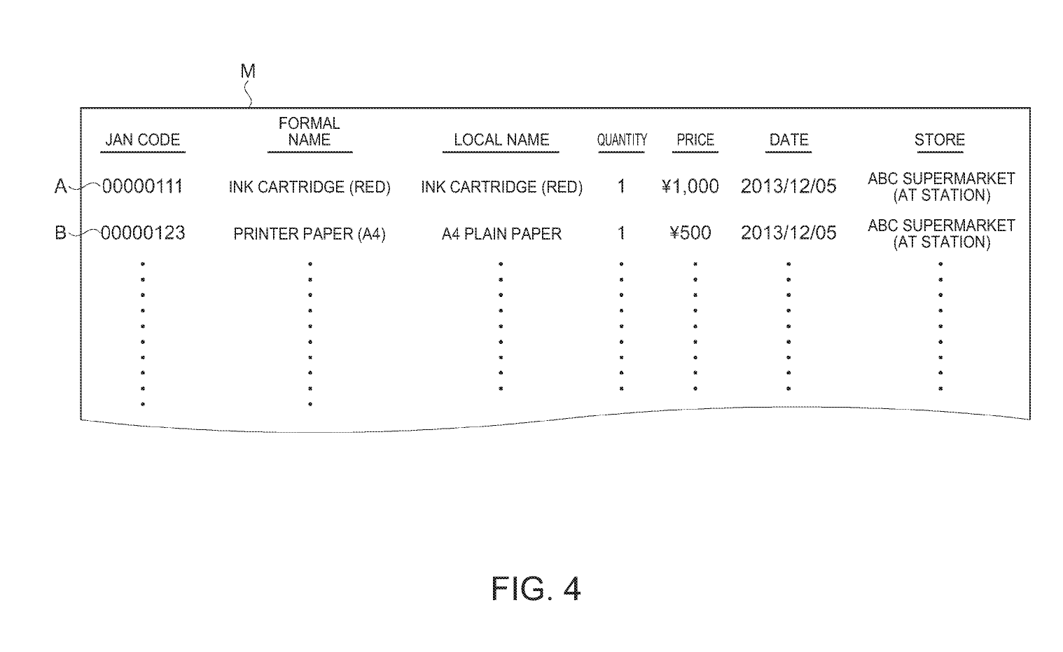

FIG. 4 shows an example of the sales information generated by the information synthesis utility 210 in the first embodiment of the invention. In FIG. 4, M denotes the sales information that is generated, and includes for each sold product such information as the JAN code, formal name, local name, quantity, price, date, and store. One line (record) in the figure contains the information for one product. The quantity means the purchased quantity, the price means the sale price, the date means the date of sale, and store means the name of the store where the purchase was made.

Product A in FIG. 4 shows an example in which the formal name commonly used for marketing, and the local name used in the store, are the same, that is, “ink cartridge (red).” Product B shows an example in which the common formal name used for marketing ((printer paper (A4)) and the local name used in the store (A4 plain paper) are different. The name used by the product manufacturer tends to be longer in order to specifically differentiate the product application, for example. Because a store only handles a limited range of products, however, the names tend to be shorter for ease of use. To analyze sales information for each, the name that is used often differs according to whether the user is the manufacturer or the store, for example.

When the above related information is acquired and stored by the information synthesis unit 211, the information set of JAN code, formal name, local name, and price will be complete. Note that the quantity in this example is always 1 because the barcode is read from each item even when multiple units of the same product are purchased.

When processing the input data for one product ends, the process from reading data with the barcode reader 24 repeats as described above for every product in the purchase (step S2 returns YES to step S5 in FIG. 3). Note that the barcode data acquisition and transfer process (S3), JAN code acquisition process (S4) and related information acquisition process (S5) are shown as sequential (continuous successive) steps in the flow chart in FIG. 3, because input of barcode data for the next product normally progresses continuously without waiting for the JAN code acquisition process (S4) and related information acquisition process (S5), the input filter driver 204 executes the acquisition and transfer of input barcode data (S3) when barcode data is input irrespective of the JAN code acquisition process (S4) and related information acquisition process (S5).

Because the barcode data for all products is input to the POS application 201 when reading data with the barcode reader 24 is completed for all products being purchased, the POS application 201 generates print data for a receipt after computing the transaction total and other information. The generated print data is output by the printer driver 202 to the output port 207 as data for the printer 21.

When print data is output (step S1 in FIG. 3 returns YES), the output filter driver 205 receives the print data before it is input to the output port 207. The output filter driver 205 acquires and passes the print data to the information synthesis unit 211 (step S6 in FIG. 3, output data acquisition step). The print data is output through the output port 207 to the printer 21. A receipt for the purchase is then printed and output based on the print data by the printer 21. The printed names of the products in the print data are the local names.

The information synthesis unit 211 interprets the transferred print data and extracts the information required for the sales information (step S7 in FIG. 3). In this example, the date of sale and store name information are extracted. This information is normally included as information printed on the receipt, and can be extracted because it is printed at a specific location on the receipt.

Next, the information synthesis unit 211 synthesizes information stored based on the input data and related information and the information extracted from the print data (step S8 in FIG. 3, synthesizing process). In the example in FIG. 4, the information of each record already stored, that is, the JAN code, formal name, local name, quantity, and price information, is combined with the date and store information. Because the sale date and store name are the same when the two products labelled A and B in FIG. 4 are purchased in a single transaction, the sale date and store name are the same for each of the products, and the same date and the same store name are combined with the information already stored.

Information from input data, related information, and information from the print data (output data) are thus combined to create sales information about the product sale. The combined information, that is, the sales information, is passed from the information synthesis unit 211 to the information output unit 213, and the information output unit 213 converts the sales information to data in a data format compatible with the sales information database 51 (such as text data) as the output information to the sales information database 51 (step S9 in FIG. 3). The generated output information is sent through the Internet 7 to the sales information server 5 (step S10 in FIG. 3). The transmitted information is then stored in the sales information database 51.

As described above, the sales information generating process is executed for each sales transaction (product sale), and sales information is accumulated in the sales information database 51 for each sales transaction (product sale).

### Embodiment 2

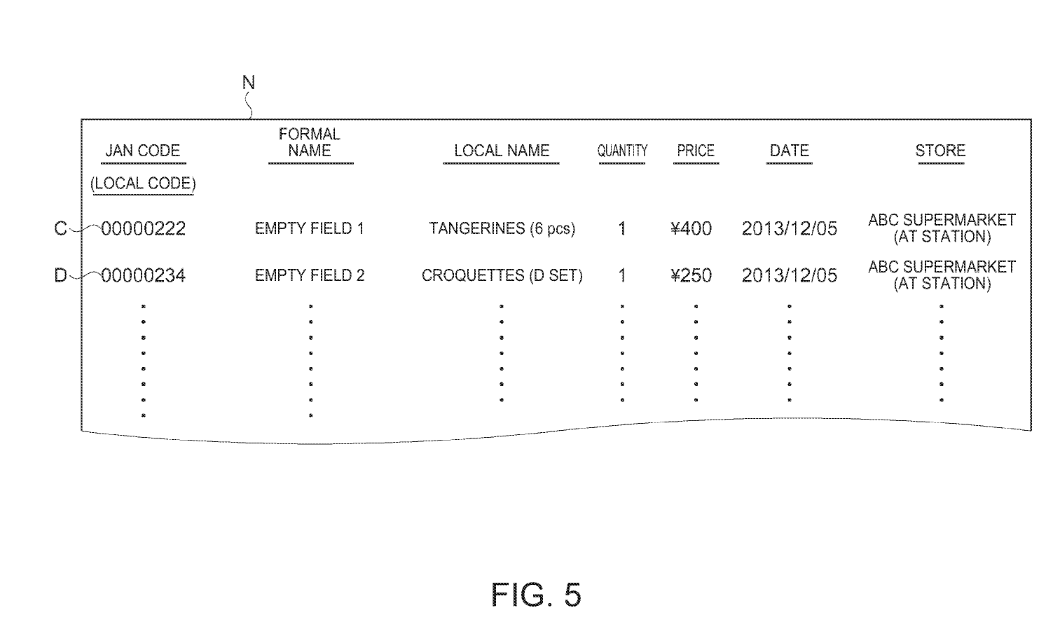

A second embodiment of the invention that uses local codes is described with reference to FIG. 5. FIG. 5 shows an example of sales information generated by the information synthesis utility 210 in the second embodiment of the invention. A local code is a product code used by the store, and this embodiment of the invention describes an example in which a local code is assigned by the store when the standard product code (such as the JAN code) is missing. More specifically, a local code is used for fresh foods and prepared foods that are cataloged by the store. Note that further description of parts and content that are the same as in the first embodiment is omitted below.

In FIG. 5, N denotes the sales information that is generated, and includes for each sold product such information as the JAN code (blank) (which equals the local code), formal name based on the JAN code, local name, quantity, price, date, and store. One line (record) in the figure expresses the information for one product. The quantity means the purchased quantity, the price means the sale price, the date means the date of sale, and store means the name of the store where the purchase was made.

A local code meaning “tangerines (6 pcs)”, which is the product the store assigned in the part of “Empty Field 1” of the JAN code, is assigned to product C in FIG. 5. A local code meaning “croquettes (D set)”, which is the product the store set in the part of “Empty Field 2” of the JAN code, is assigned to product D. As a result, in sale information N, the formal name of product C is “Empty Field 1”, and the local name is “tangerines (6 pcs)”. For product D, the formal name is “Empty Field 2”, and the local name is “croquettes (D set)”.

The sales information N is generated by the following process.

When a JAN code denoting an empty field is passed to the information synthesis unit 211 in step S3 in FIG. 3, the related information acquisition unit 212 accesses the JAN database 41 and checks the empty field (S4). The related information acquisition unit 212 then accesses the PLU database 31, and acquires the related information linked to the JAN code (local code) (S5). Note that the related information includes the local name and price, for example.

A preferred embodiment of the invention is described above, but this embodiment can be modified in many ways without departing from the scope of the accompanying claims. Some examples of such variations are described below.

The input data from a barcode reader 24 used as an example of a peripheral device that inputs data is used (synthesized) in the sales information in the embodiment described above, but input data from the keyboard and mouse 23 or card reader 25, for example, may be used (synthesized) in the sales information.

In this case, a filter driver having the same functionality as the input filter driver 204 is provided for the keyboard and mouse 23 and the card reader 25, and input data therefrom is acquired before being passed to the POS application 201 and transferred to the information synthesis unit 211.

Input data from the keyboard and mouse 23 includes the local code of products to which a barcode is not affixed, and the quantity when more than one of a product is purchased. When the local code is passed to the information synthesis unit 211, the related information acquisition unit 212 can access the PLU database 31 and acquire the JAN code corresponding to that local code. When the quantity data is passed to the information synthesis unit 211, the data is reflected in the quantity field of the sales information described above.

When the membership card of a customer is read with the card reader 25, the member identification information (ID) of that customer may be combined with the sales information as input data. When the employee card of the operator (sales clerk), for example, is read from the card reader 25, the employee identification information (ID) of that employee may also be combined with the sales information as input data. If a barcode is printed on the employee card, for example, that same data can be captured with the barcode reader 24.

Note that when the PLU database 31 cannot be used, the price information in the sales information may be extracted (acquired) from the print data for the receipt. The relationship between the price information and the JAN code acquired from the input data (barcode data) can be determined by previously analyzing the rules controlling the printing order of products on the receipt in the POS application 201, and setting the rules in the information synthesis unit 211. Alternatively, the price and local name can be extracted as a data pair from the print data, and a correlation made from the similarity between the local name and the formal name acquired as related information.

Acquisition of input data is handled by the input filter driver 204 on the OS kernel layer 230, but the input data may alternatively be acquired by acquiring a window message that the operating system passes to the application.

Note that the JAN code is used as an example of a standardized product code, but the invention is not so limited and other identification codes, such as the EAN code, UPC code, or two-dimensional code symbols, may be used.

As described above, by using the POS terminal device 2 according to this embodiment of the invention and variations thereof, information input from peripheral devices and information output to peripheral devices is acquired outside the POS application 201, and the acquired information is synthesized to generate sales information. The ability to relatively easily generate sales information without modifying the existing POS application can therefore be added to a POS system and POS application 201 that do not have the ability to generate such sales information. More specifically, this functionality can be added by installing the input filter driver 204, output filter driver 205, and information synthesis utility 210 programs on an existing POS terminal device 2.

Because the main process of generating sales information is run on the application layer 220 of a computer, program development can also be simplified.

Next, because the generated sales information combines information input from peripheral devices and information output to peripheral devices, information with higher utility value than previously can be provided. More particularly, because the JAN code is acquired and included in the generated sales information by using product barcode data, the information is also useful to others than the store that sold the product (such as the product manufacturer), and has high utility value.

Furthermore, because sale date and sale store information is included in the generated sales information, it can also be used for analyses related to when and where products are sold.

Furthermore, because the generated sales information is stored on a server that is accessible through the Internet 7, using the information is also quite convenient.

The foregoing embodiment describes an example in which the POS terminal device 2 programs are stored in ROM or on a hard disk drive, but these programs can obviously be stored in RAM or on other storage media. The programs may also be stored on separate storage media.

The foregoing embodiment acquires print data sent to the printer as the data output to a peripheral device for generating the sales information, but data output to a different peripheral device may be acquired. For example, in a POS system that outputs receipt information as digital data in the form of an electronic receipt, that data may be acquired and used to generate the sales information.

The scope of the present invention is not limited to the foregoing embodiments, and includes the invention as described in the accompanying claims and other equivalents.

### INDUSTRIAL APPLICABILITY

As described above, the present invention is applicable to an information generating method that can use the input/output data of existing devices to generate information with high utility value without modifying existing applications.

### REFERENCE SIGNS LIST

1 POS server
2 POS terminal device
3 PLU server
4 JAN server
5 sales information server
6 LAN
7 Internet
21 printer
22 display
23 keyboard and mouse
24 barcode reader
25 card reader
31 PLU database
41 JAN database
51 sales information database
201 POS application
202 printer driver
203 HID driver
204 input filter driver
205 output filter driver
206 input port
207 output port
210 information synthesis utility
211 information synthesis unit
212 related information acquisition unit
213 information output unit
214 communication port
220 application layer
230 OS kernel layer
240 physical layer

1. An information generating method of a computer with an application, comprising:
an input data acquisition step of acquiring input data input to the computer before the input data is input to the application;
an output data acquisition step of acquiring output data of the application before the output data is output from the computer; and
a synthesizing step of combining at least some of the acquired input data and at least some of the acquired output data and generating information.

2. The information generating method described in claim 1, wherein:
the application is a point-of sale (POS) application;
the input data is information about a product; and
the output data is print data for a receipt related to the product.

3. The information generating method described in claim 1, wherein:
the acquired input data includes a product code of a product.

4. The information generating method described in claim 1, wherein:
the acquired output data includes at least a sale date and store information.

5. The information generating method described in claim 3, further comprising:
a related information acquisition step of acquiring related information of the sold product from a database to which the computer connects based on the product code.

6. The information generating method described in claim 5, wherein:
the related information includes formal name and price information for the product; and
the information generated in the synthesizing step includes formal name and price information.

7. The information generating method described in claim 5, wherein:
the related information includes local name information for the product; and
the information generated in the synthesizing step includes local name information.

8. The information generating method described in claim 6, wherein:
the product code includes local code information for the product having no formal name.

9. The information generating method described in claim 1, further comprising:
an input step of inputting information from a first external device; and
an output step of outputting information generated in the synthesizing step to a second external device.

10. The information generating method described in claim 1, wherein:
the input data is input from a barcode reader as a product code; and
the output data is output to a printer as print data for a receipt.

11. The information generating method described in claim 1, wherein:
the input data acquisition step and the output data acquisition step execute on the kernel layer of the operating system of the computer; and
the synthesizing step executes on the application layer of the computer.

12. An information processing device with an application, comprising:
an input data acquisition unit that acquires input data input to the information processing device before the input data is input to the application;
an output data acquisition step that acquires output data of the application before the output data is output from the information processing device; and
an information synthesis unit that combines at least some of the acquired input data and at least some of the acquired output data and generates information.

13. A point-of-sale (POS) system, comprising:
an input device configured to acquire a product code;
an output device configured to output print data for a receipt; and
an information processing device configured to have an information synthesis unit and a POS application;
wherein the information synthesis unit acquires the product code from the input device before the product code is input to the application, acquires the print data before the print data is output from the information processing device, combines at least some of the acquired product code and at least some of the acquired print data, and generates information.
